(19) United States
(12) Patent Application Publication
(10) Pub. No.: US 2010/0318634 A1
(43) Pub. Date: Dec. 16, 2010

(54) METHOD AND SYSTEM FOR SENDING, RECEIVING AND TRANSMITTING AN OFFLINE IMAGE AND OFFLINE IMAGE SERVER

(75) Inventor: Jiajun CHEN, Shenzhen (CN)

Correspondence Address: HAMRE, SCHUMANN, MUELLER & LARSON, P.C., P.O. BOX 2902, MINNEAPOLIS, MN, 55402-0902, US

(73) Assignee: TENCENT TECHNOLOGY (SHENZHEN) COMPANY LIMITED, Shenzhen (CN)

(21) Appl. No.: 12/850,353

(22) Filed: Aug. 4, 2010

Related U.S. Application Data
(63) Continuation-in-part of application No. PCT/CN2009/071265, filed on Apr. 14, 2009.

(30) Foreign Application Priority Data
Apr. 23, 2008 (CN) 200810095030.X

(51) Int. Cl. G06F 15/16

(52) U.S. Cl. 709/219

(57) ABSTRACT

The embodiments of the present invention disclose a method and a system for sending, receiving and transmitting an offline image and an offline image server. Said method for transmitting an offline image comprises the following steps: in case the second instant messaging terminal can not directly receive an image file from the first instant messaging terminal, the offline image server receives the image file uploading request sent by the first instant messaging terminal; the offline image server returns the downloading index information of said image file to said first instant messaging terminal according to said image file uploading request, the first instant messaging terminal sends said downloading index information to the second instant messaging terminal, and the second instant messaging terminal acquires said image file according to said downloading index information. By applying the embodiments of the present invention, even in case the instant messaging terminal can not directly receive an image file, the image file may be transmitted thereto, so as to enhance the intercommunion among the users.

### FIELD OF THE INVENTION

The present invention relates to the technical field of network applications, in particular, to a method and a system for sending, receiving and transmitting an offline image and an offline image server.

### DESCRIPTION OF THE BACKGROUND ART

Instant messaging service is a kind of communication service based on Internet, generally mainly for achieving the function of instant messaging via network. Currently, instant messaging service has found wide application and recognization on the Internet, and the instant messaging service may be provided through an instant messaging software. The instant messaging softwares are widely recognized and favored by a large number of netizens due to many advantages such as a fast speed, abundant functions, and stability upon use, etc. With the existing instant messaging services, the users may among themselves carry out many kinds of operations through the instant messaging softwares such as the interchange of text information, the transfer of files, the sending of mobile terminal short messages and so on.

With the development of network techniques, the instant messaging softwares with the present development thereof have been accepted by most netizens, and have become indispensable software tools for the Internet users. The instant messaging softwares not only in the leisure-time recreations, but also during the working hours are widely used. Accordingly, the users have placed relatively greater requirements on the instant messaging softwares in the respects of availability, stability, security and so on. Among the instant messaging softwares, a humanized service may achieve more fidelity from the users.

However, with the existing instant messaging softwares, in some cases the users are restricted in their need for intercommunion. For example, since the transfer operation requires the instant messaging software at the reception side to take part in this activity, in case the other party at the reception side is offline, then a user-defined phiz and/or image file can not be sent thereto, which thus hinders the intercommunion among the users. In addition, if the other party is in the invisible state, then a user-defined phiz and/or image file can not be directly accepted either, otherwise the invisible state thereof could be revealed.

### SUMMARY OF THE INVENTION

The embodiments of the present invention propose a method and a system for sending, receiving and transmitting an offline image and an offline image server, with which the image file can be transmitted in case an instant messaging terminal is incapable of directly receiving the image file, so as to enhance the intercommunion among the users.

The technical solution of the embodiments of the present invention are as follows:

a method for sending an offline image, comprising the following steps:

in case the second instant messaging terminal can not directly receive an image file from the first instant messaging terminal, the first instant messaging terminal sends an image file uploading request to the offline image server, the offline image server returns the downloading index information of said image file to said first instant messaging terminal according to said image file uploading request;

the first instant messaging terminal sends said downloading index information to the second instant messaging terminal, the second instant messaging terminal acquires said image file according to said downloading index information.

A method for receiving an offline image, comprising the following steps:

the second instant messaging terminal receives the downloading index information sent by the first instant messaging terminal;

the second instant messaging terminal acquires the image file according to said downloading index information.

A method for transmitting an offline image, comprising the following steps:

in case the second instant messaging terminal can not directly receive an image file from the first instant messaging terminal, the offline image server receives the image file uploading request sent by the first instant messaging terminal;

the offline image server returns the downloading index information of said image file to said first instant messaging terminal according to said image file uploading request, the first instant messaging terminal sends said downloading index information to the second instant messaging terminal, and the second instant messaging terminal acquires said image file according to said downloading index information.

A system for transmitting an offline image, comprising a first instant messaging terminal, a second instant messaging terminal and an offline image server, wherein:

said first instant messaging terminal, in case the second instant messaging terminal can not directly receive an image file from the first instant messaging terminal, is used to send an image file uploading request to the offline image server, and send the downloading index information returned by the offline image server to the second instant messaging terminal;

said offline image server, is used to return the downloading index information of the image file to said first instant messaging terminal according to the image file uploading request;

said second instant messaging terminal, is used to acquire said image file according to the downloading index information.

An offline image server, wherein it comprises an offline image indexing unit and an offline image transmitting unit; wherein:

said offline image indexing unit, is used to receive the image file uploading request containing the image file hash information sent from the first instant messaging terminal, judge whether or not to receive the uploaded image file according to the image file hash information, and provide the uploading information on the offline image transmitting unit for the first instant messaging terminal in case it is judged to receive the uploaded image file, said first instant messaging terminal uploads the image file to the offline image transmitting server according to the uploading information;

said offline image transmitting unit, is used to receive the image file uploaded by the first instant messaging terminal according to the uploading information, and return the downloading index information containing the storing information of the image file in the offline image server to the first instant messaging terminal.

From the above described technical solution it can be seen that, in the embodiments of the present invention, in case the second instant messaging terminal can not directly receive an image file from the first instant messaging terminal, the first instant messaging terminal sends an image file uploading request to the offline image server, the offline image server returns the downloading index information of said image file to said first instant messaging terminal according to said image file uploading request, then the second instant messaging terminal acquires said image file according to the downloading index information provided by the first instant messaging terminal. Thereby it is seen that, by adopting the embodiments of the present invention, in case the instant messaging terminal can not directly receive an image file, the image file may be acquired from the offline image server or the image file may be directly locally downloaded, so the offline delivering of an image and the display thereof is achieved, thus enhancing the intercommunion among the users.

### BRIEF DESCRIPTIONS OF THE DRAWINGS

FIG. 1 is a flow chart of the method for transmitting an offline image according to the present invention;

FIG. 2 is a structural illustrating view of the offline image system according to the embodiment of the present invention;

FIG. 3 is a flow chart of the method for transmitting an offline image according to the embodiment of the present invention.

### DETAILED DESCRIPTION OF THE PREFERRED EMBODIMENTS

To make the object, the technical solution and the advantage of the present invention more clearly and explicitly expressed, the present invention is hereinafter described in further detail in connection with the accompanying drawings and the particular embodiments thereof.

A method for sending an offline image provided by the present invention comprises the following steps:

in case the second instant messaging terminal can not directly receive an image file from the first instant messaging terminal, the first instant messaging terminal sends an image file uploading request to the offline image server, the offline image server returns the downloading index information of said image file to said first instant messaging terminal according to said image file uploading request; wherein, the instances in which said second instant messaging terminal can not directly receive an image file from the first instant messaging terminal comprises: the second instant messaging terminal is in an offline state or the second instant messaging terminal is in a invisible state;

the first instant messaging terminal sends said downloading index information to the second instant messaging terminal, the second instant messaging terminal acquires said image file according to said downloading index information.

A method for receiving an offline image provided by the present invention comprises the following steps:

the second instant messaging terminal receives the downloading index information sent by the first instant messaging terminal; wherein, said downloading index information is the downloading index information local to the second instant messaging terminal, or said downloading index information contains the storing information of the uploaded image file in the offline image server;

the second instant messaging terminal acquires the image file according to said downloading index information; wherein, the steps with which the second instant messaging terminal acquires the image file according to said downloading index information specifically comprises the following steps:

the second instant messaging terminal judges whether said downloading index information is valid and if valid, then it will download said image file from the offline image server or locally from the second instant messaging terminal and displays the same; if invalid, then the second instant messaging terminal will replace said offline image with a replacement image and displays the latter.

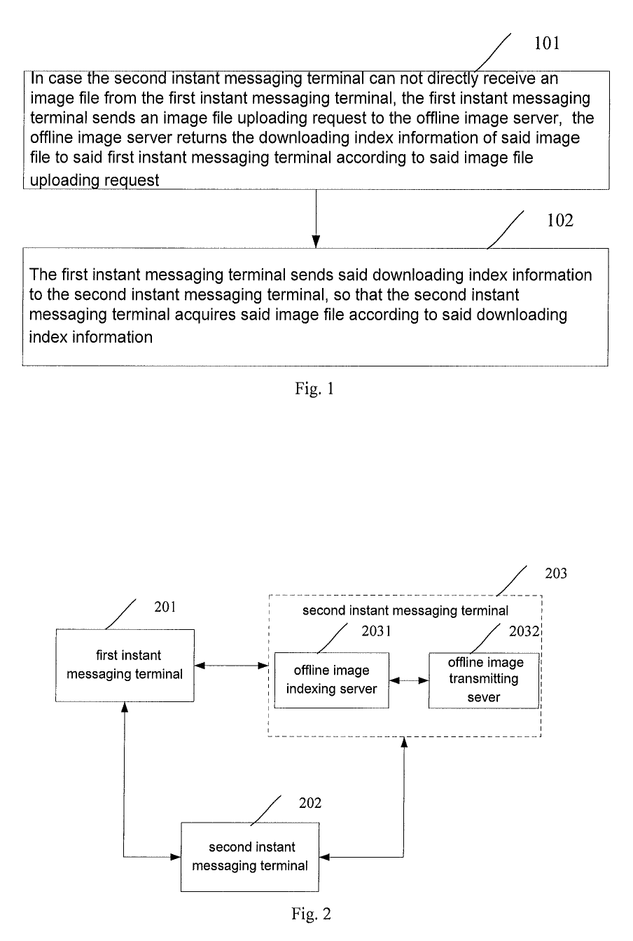

FIG. 1 is a flow chart of the method for transmitting an offline image according to the present invention. By adopting the present flow, in case the other party is in an invisible or offline state, a message carrying an image may be sent thereto, and the image in the message will be sent in a form of an offline image.

As shown in FIG. 1, the method for transmitting an offline image comprises:

Step 101: in case the second instant messaging terminal can not directly receive an image file from the first instant messaging terminal, the first instant messaging terminal sends an image file uploading request to the offline image server, and the offline image server returns the downloading index information of said image file to said first instant messaging terminal according to said image file uploading request.

Herein, the instances in which the second instant messaging terminal can not directly receive an image file from the first instant messaging terminal comprise: the second instant messaging terminal is in an offline state or invisible state and so on. The invisible state is defined with respect to the sending part. In case both parties interacting with each other through chatting just finished speaking, it is considered that both parties are online, and a direct connection may be established so as to send an image file.

The image file uploading request may include the hash information of the image file, and the offline image server judges whether or not to receive the uploaded image file according to the hash information of the image file. If it is judged that the hash information of the image file is the same as the hash information of the image file already existent in the offline image server, then it is shown that the image file is already saved in advance in the offline image server and the uploading thereof needs not to be accepted. If it is judged that the hash information of the image file is equal to the hash information of a frequently used user-defined phiz, then at this point the image file needs not to be accepted either, and the image file may be locally acquired directly from the second instant messaging terminal. Generally, the second instant messaging terminal has already stored various frequently used user-defined phizes locally.

If it is judged that the hash information of the image file is not the same as the hash information of the image file already existent in the offline image server, and the image file is not a user-defined phiz, then it is judged to receive the image file. At this point, the first instant messaging terminal uploads the image file to the offline image server, and the downloading index information returned by the offline image server to the first instant messaging terminal contains the storing information of the uploaded image file in the offline image server; or the offline image server returns the local downloading index information of the image file to the first instant messaging terminal, and the second instant messaging terminal locally acquires said image file from the second instant messaging terminal according to the local downloading index information.

Herein, after the offline image server receives the image file uploading request, the offline image server may further judge whether the first instant messaging terminal satisfies a preset uploading requirement, and in case it is judged that uploading requirement is satisfied, it returns the downloading index information of the image file to the first instant messaging terminal.

Herein, the preset uploading requirements may comprise: the first instant messaging terminal possesses the uploading authority, the number of the image files uploaded by the second instant messaging terminal has not reached a limit value and the offline image server is running properly, and so on.

For example, it is assumed that the preset uploading requirement is related to the uploading authority, that is, it is considered that the uploading requirement is satisfied only when the second instant messaging terminal possesses the uploading authority. In case the offline image server receives the image file uploading request, it is first judged whether the second instant messaging terminal possesses the uploading authority. Only when the second instant messaging terminal possesses the uploading authority would the offline image server perform the corresponding process, so as to return the downloading index information of the image file to the first instant messaging terminal. If the second instant messaging terminal lacks the uploading authority, then the offline image server will not accept uploading.

Step 102: the first instant messaging terminal sends said downloading index information to the second instant messaging terminal, and the second instant messaging terminal acquires the image file according to the downloading index information.

Herein, the second instant messaging terminal judges whether the downloading index information is valid and if valid, then it downloads said image file from the offline image server or locally from the second instant messaging terminal and displays the same; if invalid, then the second instant messaging terminal will replace said offline image with a replacement image (for instance, to represent a failed display of image with a red cross) and displays the latter.

The embodiment of the present invention further proposes a system for transmitting an offline image.

FIG. 2 is a structural illustrating view of the offline image system according to the embodiment of the present invention.

As shown in FIG. 2, the system comprises a first instant messaging terminal 201, a second instant messaging terminal 202 and an offline image server 203, wherein the first instant messaging terminal 201, in case the second instant messaging terminal 202 can not directly receive an image file from the first instant messaging terminal 201, is used to send an image file uploading request to the offline image server 203, and send the downloading index information returned by the offline image server 203 to the second instant messaging terminal 202; the offline image server 203, is used to return the downloading index information of the image file to the first instant messaging terminal 201 according to the image file uploading request; the second instant messaging terminal 202, is used to acquire the image file according to the downloading index information.

Herein, the first instant messaging terminal 201 may send the image file uploading request to the offline image server 203 in case the second instant messaging terminal 202 is in an offline state or invisible state.

The offline image server 203 specifically may comprise an offline image indexing server 2031 and an offline image transmitting server 2032; wherein the offline image indexing server 2031, is used to receive the image file uploading request containing the image file hash information sent from the first instant messaging terminal 201, judge whether or not to receive the uploaded image file according to the image file hash information, and provide the uploading information on the offline image transmitting sever 2032 for the first instant messaging terminal 201 in case it is judged to receive the uploaded image file.

Specifically, the offline image indexing server 2031 judges whether to receive the uploaded image file according to the image file hash information and if it is judged to receive, then the first instant messaging terminal uploads the image file to the offline image transmitting server 2032, the downloading index information returned by the offline image transmitting server 2032 to said first instant messaging terminal 201 contains the storing information of the uploaded image file in the offline image server; if it is judged that the image file need not be received according to the image file hash information, then the offline image indexing server 2031 returns the local downloading index information of the image file to said first instant messaging terminal 201, the first instant messaging terminal 201 sends the local downloading index information to the second instant messaging terminal 202, and the second instant messaging terminal 202 acquires the image file locally from the second instant messaging terminal 202 according to the local downloading index information. In cases the authority of the first instant messaging terminal 201 is insufficient, or the number of the uploaded images has reached a limit value, the offline image transmitting server 2032 may refuse to receive the image file uploaded by the first instant messaging terminal 201.

The first instant messaging terminal 201 is used to upload the image file to the offline image transmitting server 2032 according to the uploading information of the offline image transmitting server 2032; the offline image transmitting server 2032 is used to return the downloading index information containing the storing information of the uploaded image file in the offline image server 2032 to said first instant messaging terminal 201. The uploading information regarding the offline image transmitting server 2032 comprises any piece or any combination of more than two pieces of the following information: the IP address of the image transmitting server; the port of the image transmitting server; the Key information for uploading validation, In addition, the image files may comprise various user-defined phizes and/or pictures.

The second instant messaging terminal 202 is further used to judge whether the downloading index information is valid. For example, the second instant messaging terminal 202 judges whether the downloading index information is the valid URL information and if the URL information is valid, then the downloading index information is considered to be valid. Otherwise, invalid, or the second instant messaging terminal 202 judges whether the downloading index information corresponds to the identifier of a frequently used user-defined phiz and if so, then the downloading index information is considered to be valid, Otherwise, invalid. In case the downloading index information is judged to be valid, the second instant messaging terminal 202 downloads said image file from the offline image server 203 or locally from the second instant messaging terminal 202 and displays the same; if invalid, then the second instant messaging terminal will replace the offline image with a replacement image and displays the latter.

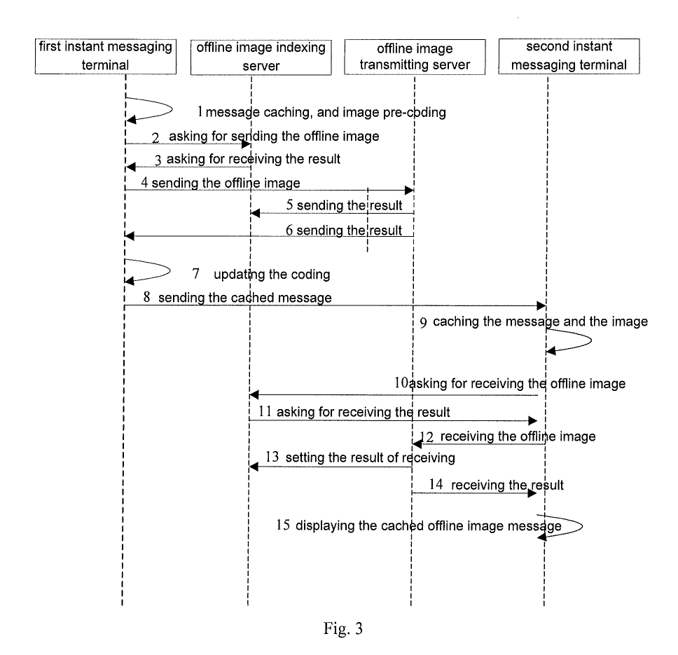

FIG. 3 is a flow chart of the method for transmitting an offline image according to the embodiment of the present invention.

As shown in FIG. 3, the method comprises:

Step 1: the first instant messaging terminal caches the instant messaging message intended to be sent, which is sent after delaying several seconds, and will replace the image in the body of the instant messaging message with an encoded format (for example: which starts and ends with a special symbol, contains the information as the type of the image, the size of the image, the image file hash information and so on, if an image is present repeatedly, then the coding merely is required to show to which image in the present message it is identical so as to save the transmitting load).

Step 2: the first instant messaging terminal sends the image file uploading request to the offline image indexing server, which request contains the image file hash information.

Step 3: the offline image indexing server, after receiving the image file uploading request, provides three results of reply according to the analysis of the image file hash information:

(1) in case there is no such an image file in the offline image indexing server and the offline image transmitting server and the image file is not a frequently used phiz, the uploading of the image file is permitted;

(2) the uploading of the image file is not needed (if the server already has the image file or the image file is an existing phiz file). At this point, the offline image indexing server returns the downloading index information, and the first instant messaging terminal will directly proceed to step 7 by skipping steps 4-6;

(3) the uploading of the image file is refused (for example, the uploading authority of the first instant messaging terminal is insufficient, the number of the image files saved by the offline image transmitting server has reached a limit value, or an error occurs in the offline image indexing server and the offline image transmitting server). In both cases when the uploading is permitted and when the uploading is not needed, the response returned by the offline image indexing server to the first instant messaging terminal will contain the offline image downloading information. When uploading is needed, the IP of the particular offline image transmitting server in charge of uploading, the port, the uploading validation key, the downloading index information and so on will also be returned. When the uploading is refused, the reason therefore will also be contained. If the uploading is refused due to the reasons such as an insufficient authority, the number of the uploaded images reaching a limit value and so on, then the first instant messaging terminal will not attempt to send other images in the message, and may exit the present flow.

Step 4: the first instant messaging terminal with the information as the uploading validation key returned in step 3 and so on connects to the designated offline image transmitting server for uploading. Due to the immensity of the group of the instant messaging terminals, generally there may be a plurality of offline image transmitting servers, and the offline image indexing server designates the particular offline image transmitting server providing the service for the first instant messaging terminal.

Step 5: upon a successful uploading of the first instant messaging terminal, the offline image transmitting server sends the result of uploading to the offline image indexing server.

Step 6: the offline image transmitting server directly returns the result of uploading to the first instant messaging terminal, or the offline image indexing server returns the result of uploading to the first instant messaging terminal.

Step 7: if the uploading is successful, then the first instant messaging terminal inserts the downloading index information returned in step 3 into the image coding, and if there are other offline images in the message waiting to be uploaded, then proceeds to step 2.

Step 8: in case the uploading of each image by the first instant messaging terminal ends with a certain result or the delay of the message expires the maximum period, the instant messaging message delayed is sent out.

The second instant messaging terminal upon receiving the instant messaging message with an offline image will enter the flow for receiving the offline image, which comprises:

Step 9: the second instant messaging terminal checks the image information in the message (searching the image coding in the body of the message) and if there is no valid offline image downloading information, or the downloading of all the images in the valid offline image information is not needed (the image is judged to be existing locally according to the image file hash information), then the entire piece of message is directly processed and displayed (already directly displayed locally, to be replaced with an error image at the image without the downloading information), and the flow terminates here.

Step 10: the second instant messaging terminal applies for downloading to the offline image indexing server according to the downloading index information.

Step 11: the offline image indexing server returns the result of the application, if the downloading is permitted, then the information as the IP of the particular downloading server, the port, the downloading validation key and so on is contained, if the downloading is refused, then the reason for the refusal is contained.

Step 12: the second instant messaging terminal with the information as the uploading validation key returned in step 11 and so on connects to the designated offline image transmitting server for downloading.

Step 13: upon a successful downloading of the second instant messaging terminal, the offline image transmitting server notifies the offline image indexing server of the downloading result.

Step 14: the offline image indexing server returns the result of downloading to the second instant messaging terminal.

Step 15: in case the downloading of each image needed to be downloaded in the offline message ends with a certain result or the maximum delay period is expired, the message is processed and displayed (if the maximum delay period is expired, then the offline image the downloading of which is incomplete is replaced with an image representing an occurent downloading, and the actual offline image is displayed after the downloading thereof is finished), otherwise proceed to step 10 so as to continue to download other offline images the downloading of which is incomplete.

In case the offline message contains the text and image, the second instant messaging terminal after receiving the offline message, acquires the image file locally or from the offline image server, and displays the image file at the original position of the offline image in the offline message, so as to ensure that the positions of the text and the image are maintained, thus enable the correct display in the original order of the text and image.

To sum up, in the embodiments of the present invention, in case the instant messaging terminal can not directly receive an image file, the image file may be acquired from the offline image server or directly downloaded locally, thus enhancing the intercommunion among the users.

Specifically, in the embodiments of the present invention, the message and the image as a phiz and so on are linked mutually so as to be sent as a piece of offline information. For example, in a piece of instant messaging message, an image as a phiz and so on may be contained, in case the receiving party is offline or invisible, that party may receive a notification prompting the user to get the message (the phiz and so on of the message is present in the offline image server, if this phiz has been used by other users, then the uploading of it is not needed at the beginning when it is to be uploaded to the offline image server), then the display thereof at the receiving party is realized. In addition, the receiving party may also receive the notification in the invisible state, and may get the message from the offline image server without revealing the invisible state thereof.

The above are only relatively preferred embodiments of the present invention, instead of limiting the scope of protection of the present invention thereto. Any changes, equivalent substitutions and modifications made within the spirit and principle of the present invention should be covered by the scope of protection of the present invention.

1. A method for sending an offline image, comprising the following steps:
in case the second instant messaging terminal can not directly receive an image file from the first instant messaging terminal, the first instant messaging terminal sends an image file uploading request to the offline image server, the offline image server returns the downloading index information of said image file to said first instant messaging terminal according to said image file uploading request;
the first instant messaging terminal sends said downloading index information to the second instant messaging terminal, the second instant messaging terminal acquires said image file according to said downloading index information.

2. The method for sending an offline image according to claim 1, wherein the instances in which said second instant messaging terminal can not directly receive an image file from the first instant messaging terminal comprise:
the second instant messaging terminal is in an offline state or the second instant messaging terminal is in an invisible state.

3. A method for receiving an offline image, comprising the following steps:
the second instant messaging terminal receives the downloading index information sent by the first instant messaging terminal;
the second instant messaging terminal acquires the image file according to said downloading index information.

4. The method for receiving an offline image according to claim 3, wherein said downloading index information is the downloading index information local to the second instant messaging terminal, or said downloading index information contains the storing information of the uploaded image file in the offline image server.

5. The method for receiving an offline image according to claim 4, wherein the steps with which the second instant messaging terminal acquires the image file according to said downloading index information specifically comprises the following steps:
the second instant messaging terminal judges whether said downloading index information is valid and if valid, then it will download said image file from the offline image server or locally from the second instant messaging terminal and displays the same; if invalid, then the second instant messaging terminal will replace said offline image with a replacement image and displays the latter.

6. A method for transmitting an offline image, comprising the following steps:
in case the second instant messaging terminal can not directly receive an image file from the first instant messaging terminal, the offline image sever receives the image file uploading request sent by the first instant messing terminal;
the offline image server returns the downloading index information of said image file to said first instant messaging terminal according to said image file uploading request, the first instant messaging terminal sends said downloading index information to the second instant messaging terminal, and the second instant messaging terminal acquires said image file according to said downloading index information.

7. The method for transmitting an offline image according to claim 6, wherein the instances in which said second instant messaging terminal can not directly receive an image file from the first instant messaging terminal comprise:
the second instant messaging terminal is in an offline state or the second instant messaging terminal is in an invisible state.

8. The method for transmitting an offline image according to claim 6, wherein said image file uploading request contains the image file hash information;
the steps in which said offline image server returns the downloading index information of said image file to the first instant messaging terminal according to said image file uploading request specifically comprise the following steps:
said offline image server judges whether to receive said image file according to said image file hash information and if it is judged to receive, then the offline image server receives the image file uploaded by the first instant messaging terminal, the downloading index information returned by the offline image server to said first instant messaging terminal contains the storing information of said uploaded image file in said offline image server; if it is judged that the image file need not to be received, then the offline image server returns the local downloading index information of said image file to said first instant messaging terminal.

9. The method for transmitting an offline image according to claim 6, wherein said image file comprises a user-defined phiz and a picture.

10. The method for transmitting an offline image according to claim 6, wherein after the step in which said offline image server receives the image file uploading request sent by the first instant messaging terminal, said method further comprises the following steps:
said offline image server judges whether said second instant messaging terminal satisfies the uploading requirement, in case the uploading requirement is judged to be satisfied, performs the step in which said offline image server returns the downloading index information of said image file to said first instant messaging terminal according to said image file uploading request.

11. The method for transmitting an offline image according to claim 10, wherein said satisfying the uploading requirement comprises satisfying any one or any combination of more than two of the following requirements:
the second instant messaging terminal possesses the uploading authority;
the number of the image files uploaded by the second instant messaging terminal has not reached a limit value;
the offline image server is running properly.

12. A system for transmitting an offline image, comprising a first instant messaging terminal, a second instant messaging terminal and an offline image server, wherein:
said first instant messaging terminal, in case the second instant messaging terminal can not directly receive an image file from the first instant messaging terminal, is used to send an image file uploading request to the offline image server, and send the downloading index information returned by the offline image server to the second instant messaging terminal;
said offline image server, is used to return the downloading index information of the image file to said first instant messaging terminal according to the image file uploading request;
said second instant messaging terminal, is used to acquire said image file according to the downloading index information.

13. The system for transmitting an offline image according to claim 12, wherein the instances in which said second instant messaging terminal can not directly receive an image file from the first instant messaging terminal comprise:
the second instant messaging terminal is in an offline state or the second instant messaging terminal is in a invisible state.

14. The system for transmitting an offline image according to claim 12, wherein said offline image server comprises an offline image indexing server and an offline image transmitting server; wherein:
said offline image indexing server, is used to receive the image file uploading request containing the image file hash information sent from the first instant messaging terminal, judge whether or not to receive the uploaded image file according to the image file hash information, and provide the uploading information on the offline image transmitting sever for the first instant messaging terminal in case it is judged to receive the uploaded image file, said first instant messaging terminal uploads the image file to the offline image transmitting server according to the uploading information;
said offline image transmitting server, return the downloading index information containing the storing information of the image file in the offline image server to the first instant messaging terminal.

15. The system for transmitting an offline image according to claim 14, wherein said uploading information regarding the offline image transmitting server comprises any piece or any combination of more than two pieces of the following information:
the IP address of the image transmitting server;
the port of the image transmitting server;
the Key information for uploading validation.

16. The system for transmitting an offline image according to claim 12, wherein said image file comprises a user-defined phiz and a picture.

17. The system for transmitting an offline image according to claim 12, wherein said second instant messaging terminal is further used to judge whether said downloading index information is valid, and if valid, then it will download said image file from the offline image server or locally from the second instant messaging terminal and displays the same; if invalid, then it will replace said offline image with a replacement image and displays the latter.

18. An offline image server, wherein it comprises an offline image indexing unit and an offline image transmitting unit;
wherein said offline image indexing unit, is used to receive the image file uploading request containing the image file hash information sent from the first instant messaging terminal, judge whether or not to receive the uploaded image file according to the image file hash information, and provide the uploading information on the offline image transmitting unit for the first instant messaging terminal in case it is judged to receive the uploaded image file, the first instant messaging terminal uploads the image file to the offline image transmitting server according to the uploading information;
said offline image transmitting unit, is used to receive the image file uploaded by the first instant messaging terminal according to the uploading information, and return the downloading index information containing the storing information of the image file in the offline image server to the first instant messaging terminal.

19. The offline image server according to claim 18, wherein said uploading information regarding the offline image transmitting server comprises any piece or any combination of more than two pieces of the following information:
the IP address of the image transmitting server;
the port of the image transmitting server;
the Key information for uploading validation.

20. The offline image server according to claim 18, wherein said image file comprises a user-defined phiz and a picture.
